(19) United States
(12) Patent Application Publication
(10) Pub. No.: US 2009/0193698 A1
(43) Pub. Date: Aug. 6, 2009

(54) Dynamic lenticular display unit

(75) Inventor: Itzhak Bar Yona, Rosh' Ha'ain (IL)

Correspondence Address: Yehuda Borenstein, 3899 Beechmont Oval, Orange Village, OH, 44122, US

(73) Assignee: Borenstein displays Inc

(21) Appl. No.: 12/012,046

(22) Filed: Feb. 1, 2008

(51) Int. Cl. G03B 25/02

(52) U.S. Cl. 40/454

(57) ABSTRACT

According to the present invention, a double sided frameless dynamic lenticular display is created by joining two spaced out lenticular panels; an indicia carrier, printed on both sides, installed in between them, while spacing means for maintaining the indicia carrier and the lenticular panels in juxtaposed position are spread over the area of the panels.

In a preferred embodiment, one of said lenticular panels is replaced by a simple panel and the indicia carrier is printed on the front side only so as to create a one sided display unit.

### FIELD OF THE INVENTION

The present invention relates to the field of lenticular displays. Specifically the invention is a lenticular display unit, capable of dynamically displaying multi-image presentations.

### BACKGROUND OF THE INVENTION

Lenticular display units of various kinds are known. Such displays are used for advertising, instructional purposes and the like. The basic optical principle of displacing a complex lithographic print relative to a lenticular linear lens array, either manually or by means of a geared motor, is known from the prior art, e.g. U.S. Pat. No. 5,494,445 discloses general know-how for consecutively displaying several images, Japanese published patent application 02211437 by Kumagai, and U.S. Pat. No. 6,226,906 by the inventor of the present invention.

In lenticular technology three basic conditions must be satisfied:
1. The information lines of the lithographic print have to be positioned in the focal points/lines of the lenses belonging to the lenticular panel.
2. The pitch distance between the information lines has to be equal to the pitch distance of the lenses of the lenticular array of lenses.
3. The information lines of the lithographic print have to be aligned with the linear lenses of the lenticular panel.

According to the method commonly used in the prior art, in order to satisfy the first condition and keep the lithographic print at the locus of the focal points of the lenses, the lenticular panel is created with a thickness equal to the focal length of the lenses. The indicia carrier, usually in a form of a printed plastic or paper sheet on which is created the printed information, is attached to the rear flat face of the lenticular panel. As a result of this arrangement, the indicia carrier remains juxtaposed to the rear flat face of the lenticular panel, i.e.—in the focal locus of the lenses, when relative movement between the indicia carrier and the lenticular panel is brought about.

While in small lenticular display units it is relatively easy to keep the indicia carrier in juxtaposed relation to the front lenticular panel this becomes more difficult to accomplish in large format display units. Practically speaking, when a large format unit, e.g. units of 1800 mm by 1200 mm, sometimes called “city format”, with a resolution of 10 lpi (lines per inch) are created, the distance from the printed information on the indicia carrier to the focal locus can vary within a range of up to 0.2 mm. If the variation is greater than this, a “ghosting effect”, i.e. a partial projection of the neighboring image together with the “main image” takes place. Extruded or injected lenticular panels produced using conventional techniques have a uniform thickness within the above limitation; however, they are never really planar. Therefore, unless very special and costly efforts are made in producing the sheets, when the lenticular sheet and indicia carrier are supported in parallel planes, there are typically enough locations on a display of this size, in which the variations in distance between print and lens exceed the allowed value, render a useless display from a commercial point-of-view. For this reason it is not possible to create large format displays using prior art display devices, such as the one described in JP 02211437. The display unit taught in this publication consists of attaching the planar indicia carrier to a rigid frame and displacing it parallel to the frontal lenticular panel. It is clear that this does not even address the problem of compensating for the deviations from a planar surface of the backside of the lenticular panel.

A long felt need, especially by media companies, is to upgrade existing passive signs into dynamic multi image ones. Attempts have been made to install lenticular display units within the light boxes of existing bus stop station signs for example. Since the width of the empty space in the interior of such light boxes is sometimes limited to less than 40 mm, it is quite impossible to use for this purpose, a robust frame such as is used attempting to maintain the spatial relationships between the various elements of the dynamic displays made according to existing methods.

It is therefore the objective of the present invention to provide a frameless, thick dynamic lenticular display unit, capable of being integrated into the interior of existing passive signs.

Being a thick unit it can be installed in any displaying facility such as a frame to be hang on a wall or elsewhere; a counter construction to be positioned at the entry of a shop, any point of sale means, such as racks, headers, and the like.

Another object of the invention is to provide a lenticular sign in which replacement and alignment of the printed indicia carrier relatively to the lenticular panel can be regulated on sight by the end user or by a simple untrained worker.

Further purposes and advantages of this invention will appear as the description proceeds.

### SUMMARY OF THE INVENTION

In the present application, the following definitions are used:
“A lenticular panel” is a transparent panel with a front face comprising an array of linear lenses.
“A dynamic lenticular display unit” is a display unit capable of displaying two or more alternating images. A dynamic lenticular display unit is comprised of at least: one lenticular front panel; indicia carrier including at least one lithographic interlaced prints; and drive means causing relative movement between said panels and said indicia carriers.
“Two sided lenticular display” has two lenticular panels, wherein a printed indicia carrier is installed between them, therefore capable of displaying the images on both sides.
“One sided lenticular display” has a front lenticular panel and a rear simple planar panel, wherein the printed information is displayed to the viewer on one side only.
“An interlaced print” is a composed lithographic print, as shown for example in FIG. 1C, consisting of lines of information, which are received by slicing and interlacing two or more basic images, as illustrated, for example, in FIGS. 1A and 1B.
“Spacing means” are pins, counter locked to a predetermined position, by bolts. Spread over the display unit, they penetrate both panels, while the indicia carrier being free to move between them, in a predetermined juxtaposed position.
“Aligning means” are means for assuring a displacement of the indicia carrier in a direction perpendicular to the linear lenses while being in constant movement.

According to the present invention, a double sided dynamic lenticular display is created by joining two spaced out lenticular panels; an indicia carrier, printed on both sides, installed in between them, while spacing means for maintaining the indicia carrier and the lenticular panels in juxtaposed position are spread over the area of the panels.

In one sided display unit, one of the lenticular panels is replaced by a simple panel and the indicia carrier is printed on the front side only.

According to the present invention the spacing means are also aligning means, in a way that will be farther illustrated with reference to the chosen embodiments.

As a result of its structure, a display unit according to the invention, has several advantages over the prior art. Specific examples of these advantages are:
Since a robust constructional frame is not necessary to support the indicia carrier relative to the lens sheet, the display unit of the invention can easily be installed in already existing signs, upgrading their ability to display “eye catching” moving images.
Replacement of the indicia carrier is easy to execute by an untrained end user. As a result, printed information in a form of sheets or printed boards can be commercially provided by a central location to remote places, permitting each local user installment or replacement of the advertised messages time and again.
Having no supporting frame, the unit, according to the invention is a kind of simple “active poster” which can be produced, shipped and assembled at a minimum cost.
When double sided lenticular displays are used, inexpensive advertising messages can be displayed on both sides using a single indicia carrier

The invention is typically a lenticular display unit for displaying consecutively changing images comprising,
(a) A front transparent lenticular panel,
(b) An indicia carrier juxtaposed to the rear face of said lenticular panel,
(c) A rear supporting panel.
(d) Spacing means protruding said panels and said indicia carrier maintaining the indicia carrier juxtaposed to the rear face of the lenticular panel, (in chosen embodiments, these spacing means are also aligning means).
(e) Drive means generating periodic relative movement between the indicia carrier and its corresponding panels.

In the case of double sided display, said rear supporting panel is replaced by lenticular panel and the indicia carrier is printed on both sides.)

In a preferred embodiment, lighting panel is introduced between two transparent indicia carriers and complementary lenticular panels.

All the above and other characteristics and advantages of the invention will be further understood through the following illustrative and non-limitative description of preferred embodiments thereof, with reference to the appended drawings. With specific reference now to the figures in detail, it is stressed that no attempt has been made to show structural details of the invention in more detail than necessary for a fundamental understanding of the invention, the description taken with the drawings making apparent to those skilled in the art, how the several forms of the invention may be embodied in practice.

### BRIEF DESCRIPTION OF THE DRAWINGS

FIGS. 1A, 1B, and 1C are advertising images illustrating the art of lenticular technology.

FIG. 2 is an exploded illustration of a display unit, according to the invention.

FIGS. 3A and 3B respectively are front and side view of the same display unit.

FIGS. 4A, 4B, and 4C are illustrations of drive module.

FIGS. 5A and 5B illustrate the principles of spacing means according to the invention.

FIGS. 6A and 6B are rear and side views of another embodiment, according to the invention.

### DETAILED DESCRIPTION OF THE INVENTION

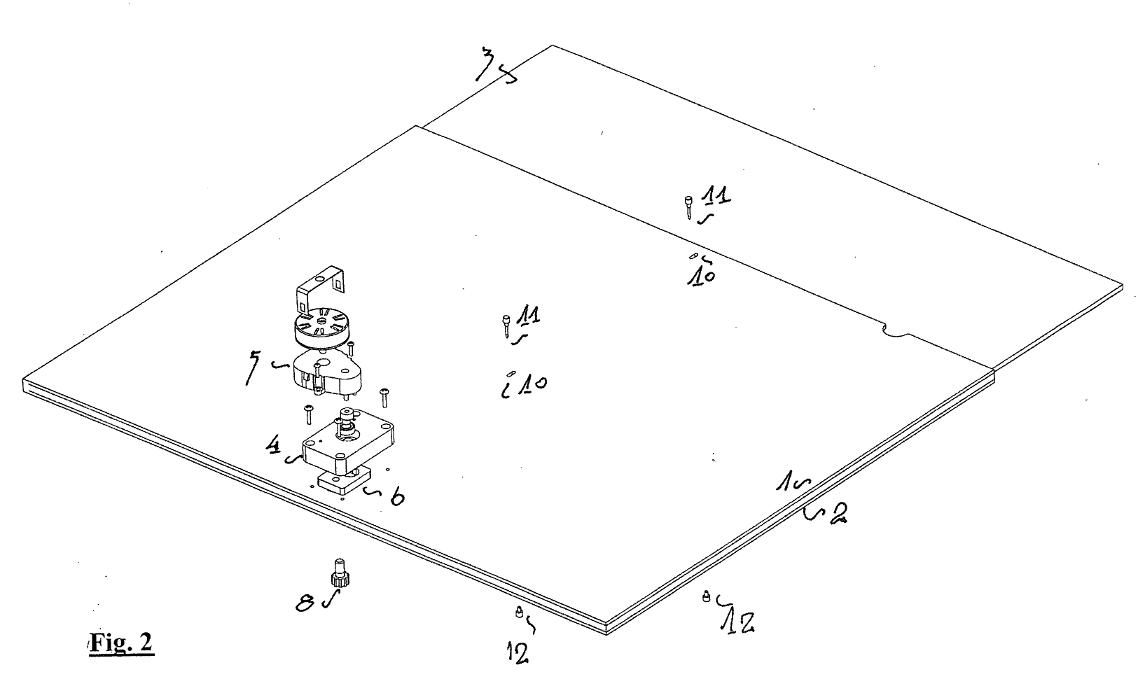

FIG. 2 is an exploded illustration of a double sided display unit, according to the present invention.

This embodiment comprises: spaced out, front and rear lenticular panels 1 and 2; Interlaced indicia carrier 3; geared motor 5 to be connected to its base unit 4; and knob 8 to be screwed into a puncture (not seen) near the edge of indicia carrier 3.

Spacing means in a form of pins 11 and their counter-locked bolts 12, are meant to penetrate lenticular panels 1 and 2 keeping them in a uniform spaced out distance.

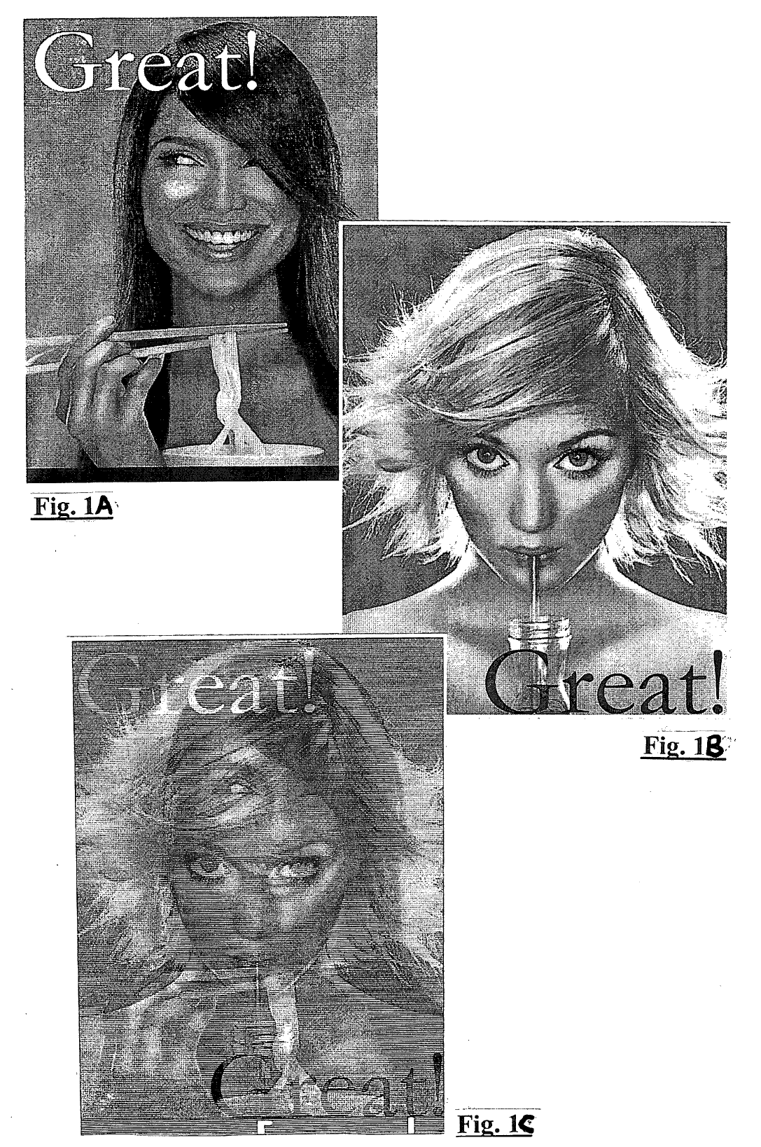

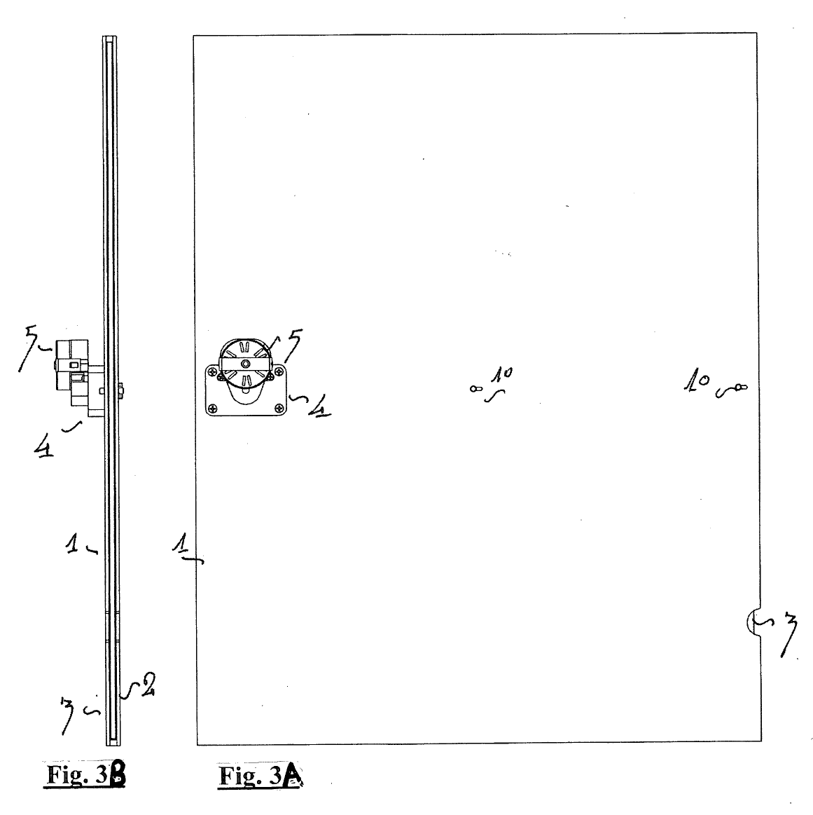

FIG. 3A and FIG. 3B are front and side views of the unit described in FIG. 2. It consists of front lenticular panel 1 and rear lenticular panel 2, spaced out so as to include slid able indicia carrier 3 in-between. In this embodiment, indicia carrier 3 is a rigid panel printed on its front and back side with interlaced images such as illustrated in FIG. 1C. Displacing indicia carrier 3, relatively to lenticular panel 1 and 2, results in consecutively displaying the basic images of interlaced indicia carrier 3 on both sides.

Connected to base unit 4, geared motor 5 is used to periodically displace indicia carrier 3 relatively the static lenticular panels 1 and 2.

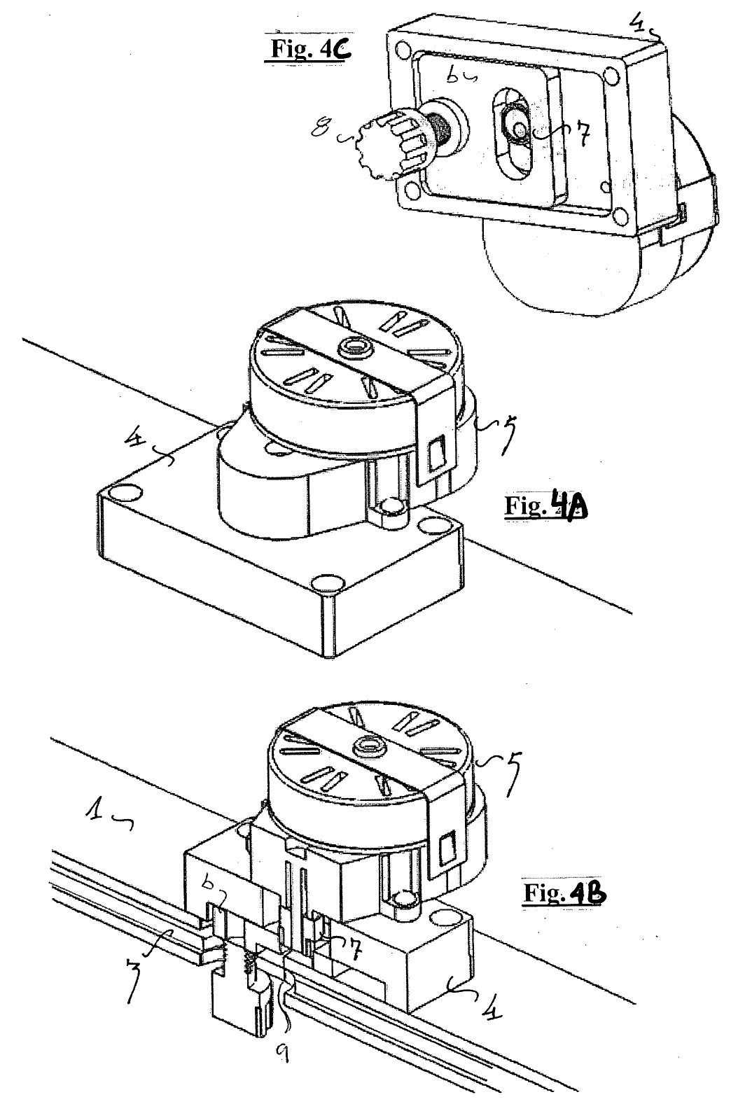

FIGS. 4A, 4B and 4C are enlarged illustrations showing the drive mechanism of the display unit. Geared motor 5 is connected to lenticular panel 1 through base unit 4. Connected to gear motor 5, eccentric ball bearing 7 displaces sliding element 6 in a direction perpendicular to the lenses of panel 1. In order to displace indicia carrier relatively to panels 1 and 2, one has to insert knob 8 through puncture 9 made in indicia carrier 3, and screw it to sliding part 6. Being activated, Geared motor 5 rotates eccentric ball bearing 5, thus causing sliding part 6 and indicia carrier 3, a periodical movement, relatively to lenticular panels 1 and 2.

As previously explained, two essential conditions have to be fulfilled here:

A. Perfect alignment of the printed information and the linear lenses.
B. Uniform leveling of the printed information in the focal locus of the lenses.

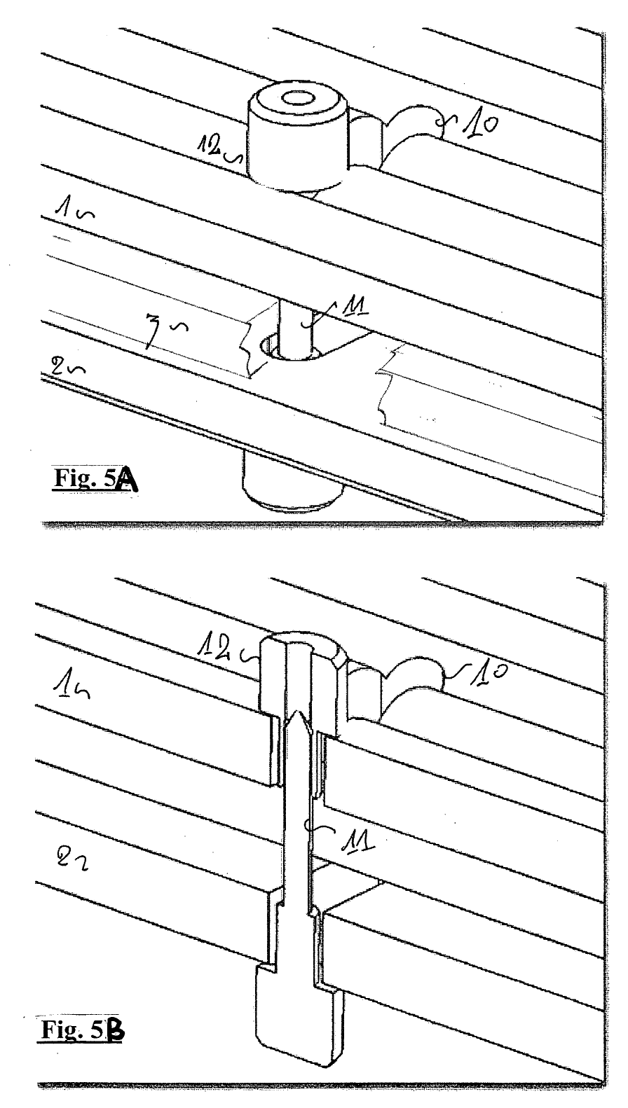

Given that plastic lenticular panels are never perfectly planar, exact juxtaposed positioning of printed information and lenticular panels is practically impossible, unless special means are used. The present invention thus provides a novel method for maintaining the uniform spatial relationship of large format display units by spreading smart spacing means over the entire area of the panels, as can be shown in FIGS. 5A and 5B.

FIG. 5A shows a typical linear puncture 10, created in front and rear lenticular panels 1 and 2. Pin 11 penetrates indicia carrier 3, (partially removed so as to expose the details of the system) being capable of a limited displacement.

A cross section of this spacing means is illustrated in FIG. 5B, showing how protruding pin 11 is counter locked into a predetermined position by bolt 12, so as to force upon panels 1 and 2 an exact special distance, while indicia carrier 3, is being free to slide in-between.

The linear punctures 10 spread over the area of the lenses actually dictate the direction of indicia carriers' movement perpendicularly to the linear lenses of panels 1 and 2. It can be realized, then, that spacing means according to the invention are efficient aligning means as well, fulfilling both the first and the second conditions above mentioned.

The embodiment herein described comprises two spacing means only; one at the center of the unit, and the second near the edge. Nevertheless, number and location of such spacing means is being determined according to the shape and the size of the panels.

Installment and replacement of the indicia carrier will be described with reference to FIG. 2. Indicia carrier 3, made, in this case, of foam board, is being printed on both sides, including the signs which will farther designate for the user the exact place for inserting intruding pins 10.

Having a puncture 9 (seen in FIG. 4B) near its edge, indicia carrier 3 has to be inserted within the space between lenticular panels 1 and 2. When the edge of indicia carrier 3 attains its final place, knob 8 has to be screwed into sliding part 6, submitting indicia carrier to periodical movement.

Protruding pins 10 are now being pushed through punctures 10, onto the marks printed on indicia carrier 3, and complementary bolts 12 are added so as to secure the pins 10 to their final position.

If intruding pins 10 are correctly inserted into the printed marks of indicia carrier 3, the linear lenses of the panels 1 and 2 and the printed lines of the interlaced images will be perfectly parallel.

Upon activating geared motor 5, the printed information of indicia carrier 3 will periodically move, complying with the basic conditions:
a. A uniform planar space is maintained between indicia carrier 3 and lenticular panels 1 and 2, while being in constant movement.
b. Perfect alignment is maintained between the interlaced images and the linear lenses on both sides of the display unit.

As the dimension of pins 10 is almost negligible, changing images of the entire display unit are practically not being disturbed.

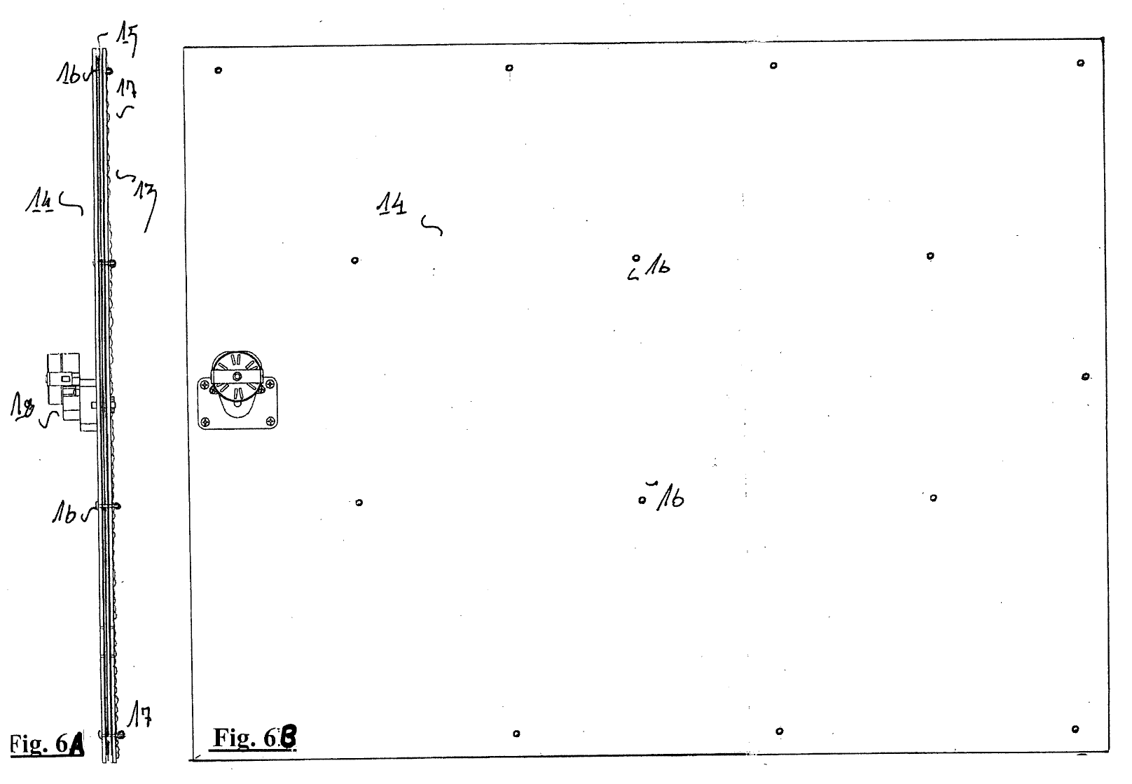

FIGS. 6A and 6B respectively, are rear and side views of another, larger embodiment of the invention. This display unit comprises of front lenticular panel 13 and rear planar panel 14 capable of relative movement between them. Spacing means 16, in a form of pins, protrude from rear panel 14, going through corresponding linear punctures such as previously illustrated with reference to FIGS. 5A and 5B. Location and direction of the spacing means 16 assures juxtaposed special relationship between panels 13 and 14 in perpendicular direction to the lenses of panel 13.

Being a larger and heavier display unit, front lenticular panel 13 is carried by two ball bearings 19 and 20 which are firmly connected to rear planar panel 14. Thus the weight of lenticular panel 3 does not fall on spacing means 16, but rather frictionless slides on ball bearing 19 and 20.

While the shaft of ball bearing 19 is centric, shaft 21 of ball bearing 20 is an eccentric one. Turning shaft 21 by the user will result in slightly tilting lenticular panel 13 relatively to the printed interlaced image of indicia carrier 15. Thus a regulating procedure is achieved, providing the user with perfect alignment of the images and the lenses.

In order to install indicia carrier 15, front lenticular panel 13 is removed from rear panel 14. Indicia carrier 15, in a form of printed sheet, can be laid and attached to rear panel 14, whereas pins 16 penetrating it through corresponding punctures or printed marks. Lenticular panel 14 is now being placed over both, rear panel 14 and indicia carrier 15, and then secured by knobs 17, such as previously described with reference to FIGS. 5A and 5B. Permanently connected to rear panel 14, drive module 18 is now capable of displacing front lenticular panel 13, relatively to the indicia carrier 15, so as to periodically display the images of interlaced print 15.

One can realize that both embodiments has no rigid frame and having the thickness of the panels only, the entire unit can be installed in existing light boxes or can be independently used in points of sale for advertising purposes.

The indicia carrier can be transparent, translucent or opaque, so as to use ambient light or back artificial light according to the given case.

In a preferred embodiment the indicia carrier can be a light defusing element, such as edge light panel, for example. In such cases, lenticular panel (or panels) is secured to this light diffusing element by spacing means, in a similar way, such as described in reference to the above mentioned embodiments.

Spacing means, such as described with reference to FIGS. 5A and 5B, are preferably made of steel, so as to minimize their size, therefore their obscuring area. Nevertheless a more advanced solution is illustrated in FIG. 5C. Penetrating pin 22 is made of steel ending in knob 24 which is made of high polished transparent plastic, such as Acryl or Polycarbonate. The upper face of knob 24 is shaped like a concave lens, creating an optical effect of diffusion. Viewing sight line 25, coming from the users' eye deviates and meets lenticular panel 1, finally attaining indicia carrier 3, which means that the viewers' sight meets the colors of indicia carrier 3, rather then steel pin 22. The same goes with bolt 24 which is optically shaped as a light diffusing lens.

The principles of the present invention will be summarized by the following claims.

1. A lenticular display unit for displaying consecutively changing images, comprising of:
Spaced out front and rear panels, wherein at least one of them is a lenticular panel,
Indicia carrier printed with interlaced print, inserted between said spaced out panels
Drive module, such as a gear motor, providing relative movement between said lenticular panel and said indicia carrier,
Spacing means spread over the area of the display unit, comprising special pins and bolts, which go through the panels and the indicia carrier, maintaining them in a uniform special relationship while being in periodical relative movement.

2. The display unit of claim 1, wherein said spaced out panels are lenticular panels, and said indicia carrier is printed on both sides, so as to display the images on both sides.

3. The display unit of claim 1 and 2, wherein said panels comprise linear punctures, being penetrated by the pins of said spacing means, in a way that the displacement of said indicia carrier is assured in a direction perpendicular to the linear lenses of said lenticular panels.

4. The display unit of claim 1 and 2, wherein said indicia carrier is a rigid lightweight board, such as foam board, corrugated board and the like, being capable of easily inserted between said two spaced out panels by an untrained user.

5. The display unit of claim 1 wherein said front panel and said rear panel are capable of relative movement, and said indicia carrier is attached to the rear panel.

6. The display of claim 1 wherein aligning means are added enabling a limited tilt between the indicia carrier and the lenticular panel.

7. The display unit of claim 1, wherein said spacing means comprises optically diffusing means, so as to minimize the distortion of the image to be displayed.

8. The display unit of claims 1-7, wherein the indicia carrier is a light transmitting element, such as an edge lit panel or a light box embodiment.

9. The display of claim 1, wherein said rear panel is self illuminated by artificial light, so as to transmit the light through the indicia carrier.
